(19) United States
(12) Patent Application Publication
(10) Pub. No.: US 2024/0172580 A1
(43) Pub. Date: May 30, 2024

(54) SYSTEM AND METHOD FOR AUTOMATICALLY LEVELING AN AGRICULTURAL IMPLEMENT USING FORWARD-LOOKING SENSOR DATA

(71) Applicant: CNH Industrial America LLC, New Holland, PA (US)

(72) Inventor: Brittany Schroeder, Bunker Hill, IN (US)

(21) Appl. No.: 18/072,407

(22) Filed: Nov. 30, 2022

(51) Int. Cl. A01B 79/00; A01B 59/042; A01B 63/24; G01S 13/88

(52) U.S. Cl. CPC A01B 79/005; A01B 59/042; A01B 63/24; G01S 13/88

(57) ABSTRACT

In one aspect, a method for automatically leveling an agricultural implement being towed by a work vehicle includes receiving data associated with a field profile of a forward portion of a field positioned in front of the work vehicle relative to a direction of travel of the work vehicle, and identifying an inclined surface within the forward portion of the field that the work vehicle will encounter as the work vehicle tows the agricultural implement across the field based at least in part on the data. The method also includes determining one or more control actions to maintain an inclination angle of the agricultural implement within a predetermined angular inclination range based at least in part on the identification of the inclined surface, and executing the one or more control actions as at least one of the work vehicle or the agricultural implement travels across the inclined surface.

### FIELD OF THE INVENTION

The present subject matter relates generally to leveling systems for agricultural implements and, more particularly, to a system and method for automatically leveling an agricultural implement using forward-looking sensor data.

### BACKGROUND OF THE INVENTION

In the continuing quest for providing greater efficiency in the operation of agricultural implements, machines have been constructed to have ever increasing lateral spans relative to a tractor or other work vehicle propelling the implement over a field. When the span increases to realize greater efficiency and speed, the criteria of having uniform and level tool contact with the soil becomes quite important. Equipment with a significant lateral span typically has many different joints and is usually articulated to enable transport to and between fields. In this regard, an area of special importance to level positioning of agricultural implements is found in the tillage field. In particular, for tillage applications, the desirable outcome is a uniform physical depth of the tillage and a uniform entry of the disc blades or other ground-engaging tools into the soil.

To date, systems have been developed for monitoring and adjusting the angular inclination of an implement. For example, U.S. Pat. No. 10,752,237 (Peterson et al.), filed on Oct. 27, 2017, discloses an automatic leveling system that utilizes sensor feedback from both vehicle-based and implement-based level sensors for adjusting the inclination of the implement. While this leveling system provides numerous advantages over conventional leveling systems, improvements and advances are still desired for further enhancing the accuracy and effectiveness of monitoring and controlling the level positioning of an implement.

Accordingly, an improved system and method for automatically leveling an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for automatically leveling an agricultural implement being towed by a work vehicle. The method includes receiving, with a computing device, data associated with a field profile of a forward portion of a field positioned in front of the work vehicle relative to a direction of travel of the work vehicle, and identifying, with the computing device, an inclined surface within the forward portion of the field that the work vehicle will encounter as the work vehicle tows the agricultural implement across the field based at least in part on the data. The method also includes determining, with the computing device, one or more control actions to maintain an inclination angle of the agricultural implement within a predetermined angular inclination range based at least in part on the identification of the inclined surface, and executing, with the computing device, the one or more control actions as at least one of the work vehicle or the agricultural implement travels across the inclined surface.

In another aspect, the present subject matter is directed to a system for automatically leveling an agricultural implement being towed by a work vehicle. The system may include a field profile sensor supported relative to the work vehicle and being configured to generate data associated with a field profile of a forward portion of a field positioned in front of the work vehicle relative to a direction of travel of the work vehicle. The system also includes a controller communicatively coupled to the field profile sensor. The controller is configured to identify an inclined surface within the forward portion of the field that the work vehicle will encounter as the work vehicle tows the agricultural implement across the field based at least in part on the data received from the field profile sensor. The controller is also configured to determine one or more control actions to maintain an inclination angle of the agricultural implement within a predetermined angular inclination range based at least in part on the identification of the inclined surface, and execute the one or more control actions as at least one of the work vehicle or the agricultural implement travels across the inclined surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a top view of one embodiment of an agricultural implement in accordance with aspects of the present subject matter:

FIG. 2 illustrates a schematic, side view of the implement shown in FIG. 1, particularly illustrating the implement being towed by one embodiment of a work vehicle in accordance with aspects of the present subject matter;

FIG. 3 illustrates a schematic view of one embodiment of a system for automatically leveling an agricultural implement being towed by a work vehicle in accordance with aspects of the present subject matter:

FIGS. 4A-4D illustrates a series of views in which a work vehicle and an implement are transitioning from a level surface to an upwardly inclined surface as the implement is being towed by the work vehicle in accordance with aspects of the present subject matter; and

FIG. 5 illustrates a flow diagram of one embodiment of a method for automatically leveling an agricultural implement being towed by a work vehicle in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for automatically leveling an agricultural implement being towed by a work vehicle. Specifically, in several embodiments, one or more field profile sensors may be installed relative to the work vehicle that have a field of view directed towards a forward portion of the field located forward of the work vehicle relative to its direction of travel. In such embodiments, a controller(s) of the disclosed system may be configured to identify inclined surfaces within the forward portion of the field based on the sensor feedback received from the field profile sensor(s). Thereafter, based on the feedback from the sensor(s), the controller(s) may be configured to control one or more actuators located on the work vehicle and/or the implement so as to maintain the inclination angle of the implement within a desired angular inclination range (e.g., an angular range defined relative to a reference plane extending perpendicular to the soil surface, such as an angular range of +/−5 degrees from the reference plane).

By identifying changes in the field terrain out in front of the work vehicle (particularly the presence of an inclined surface), the controller may anticipate upcoming changes in the vehicle's inclination angle prior to the vehicle actually travelling up or down an inclined surface within the field. Thus, the controller(s) may be configured to proactively determine suitable control actions for maintaining the desired inclination angle(s) for the implement, such as by adjusting the position of the vehicle's hitch as the vehicle encounters an inclined surface and by making further adjustments as the trailing implement subsequently transitions to the inclined surface.

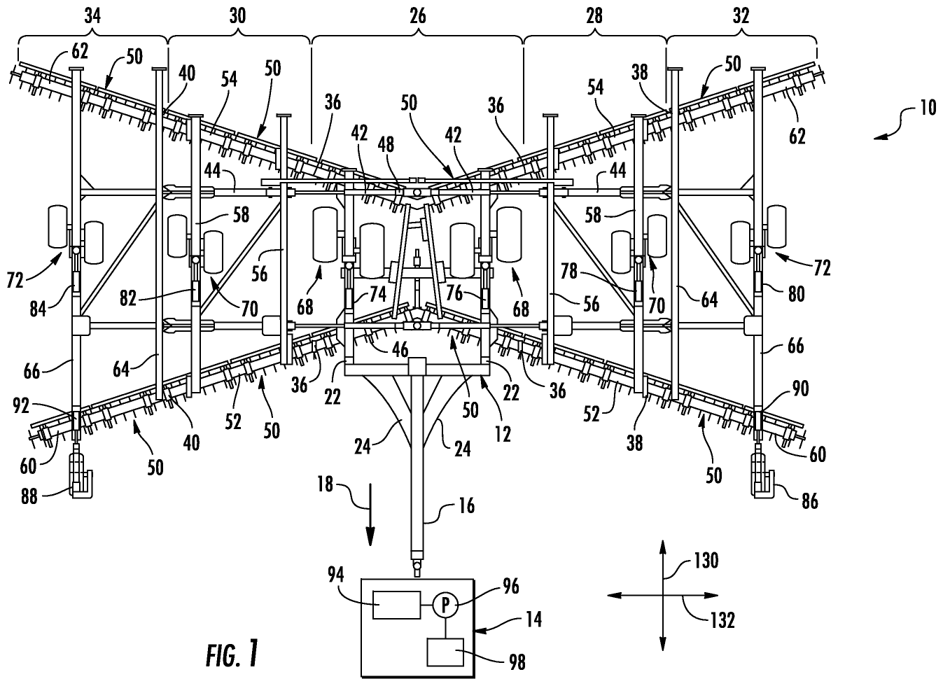

Referring now to FIG. 1, a top view of one embodiment of a multi-section implement 10 is illustrated in accordance with aspects of the present subject matter. As shown, the implement 10 is configured as a multi-section disc harrow. However, in other embodiments, the implement 10 may have any other suitable implement configuration, such as by being configured as any other suitable multi-section implement, including any other suitable tillage implement (e.g., a cultivator) or other implement (e.g., a planter, seeder, sprayer, fertilizer, and/or the like).

As shown, the implement 10 includes a carriage frame assembly 12 configured to be towed by a traction unit, such as a work vehicle (shown schematically in FIG. 1 as box 14). The carriage frame assembly 12 may generally include a pull hitch 16 extending in a forward travel direction 18 of the implement 10, and forward and aft oriented carrier frame members 22 which are coupled with and extend from the pull hitch 18. Additionally, reinforcing gusset plates 24 may be used to strengthen the connection between the pull hitch 18 and the carrier frame members 22.

As shown in FIG. 1, the tillage implement 10 is configured as a multi-section implement including a plurality of frame sections. Specifically, in the illustrated embodiment, the tillage implement 10 includes a center frame section 26, inner right and left wing frame sections 28, 30 pivotally coupled to the center frame section 26, and outer right and left wing frame sections 32, 34 pivotally coupled to the inner wing sections 28, 30. For example, the center section 26 is pivotally coupled to the inner wing sections 28, 30 at pivot joints 36. Similarly, the inner right wing section 28 is pivotally coupled to the outer right wing section 32 at pivot joints 38 while the inner left wing section 30 is pivotally coupled to the outer left wing section 34 at pivot joints 40. As is generally understood, the pivot joints 36, 38, 40 may be configured to allow relative pivotal motion between adjacent frame sections of the implement 10. For example, the pivot joints 36, 38, 40 may allow for articulation of the various frame sections between a field position, in which the frame sections are all disposed substantially in a common plane, and a transport position, in which the wing sections 28, 30, 32, 34 are folded upwardly to reduce the overall width of the implement 10.

Additionally, as shown in FIG. 1, the implement 10 may include inner wing actuator assemblies 42 coupled between the center frame section 26 and the inner wing sections 28, 30 to enable pivoting between the field and transport positions. For example, by retracting/extending the inner wing actuators 42, the inner wing sections 28, 30 may be pivoted relative to the center frame section 26 about the pivot joints 36. Moreover, the implement 10 may also include outer wing actuator assemblies 44 coupled between each inner wing section 28, 30 and its adjacent outer wing section 32, 34. As such, by retracting/extending the outer wing actuators 44, each outer wing section 32, 34 may be pivoted relative to its respective inner wing section 28, 30.

Moreover, each of the frame sections may include one or more frame members for supporting one or more ground-engaging tools. For instance, the center frame section 26 includes a forward frame member 46 coupled to the carrier frame 22 at its front end and an aft frame member 48 coupled to the carrier frame 22 at its aft end. Additionally, each inner wing section 28, 30 includes a forward frame member 52 and an aft frame member 54, with such frame members 52, 54 being interconnected by forward and aft oriented inner and outer frame members 56, 58. In one embodiment, the forward and aft frame members 52, 54 of the inner wing sections 28, 30 may generally form an extension of the forward and aft frame members 46, 48 of the center frame section 26. Similarly, each outer wing section 32, 34 includes forward and aft frame members 60, 62, with such frame members being interconnected by inner and outer frame members 64, 66.

In the illustrated embodiment, each of the frame members 46, 48, 52, 54, 60, 62 is configured to support one or more gangs of disc blades 50. In such an embodiment, the gangs of disc blades 50 may be resiliently connected to the frame members 46, 48, 52, 54, 60, 62 in any suitable manner so as to provide smooth working of the soil. However, it should be appreciated that, in other embodiments, any other suitable ground-engaging tools may be supported by the various frame members, such as shanks, tines, rolling baskets, and/or the like.

In several embodiments, the various frame sections 26, 28, 30, 32, 34 of the tillage implement 10 may be configured to be positioned at variable positions relative to the soil in order to set the position of the gangs of disc blades 50 above the soil as well as the penetration depth of the disc blades 50. For example, in the illustrated embodiment, the tillage implement 10 includes center transport wheels 68 pivotally interconnected with the carrier frames 22 so that they provide support to the forward and aft frame members 46 and 48 relative to the soil. Similarly, inner wing transport wheels 70 may be interconnected with the frame elements 58 to support and variably position the inner wing sections 28, 30 relative to the soil. In addition, outer wing transport wheels 72 may be pivotally mounted on the frame members 66 to support and variably position the outer wing sections 32, 34 relative to the soil.

In such an embodiment, wheel actuators may also be provided in operative association with the various wheels to adjust the relative positioning between the frame sections and the soil. For instance, center wheel actuators 74, 76 may be utilized to manipulate the center transport wheels 68 to establish the distance of the center frame section 26 relative to the soil while inner wing wheel actuators 78, 82 may be used to variably position the inner wing sections 28, 30 relative to the soil. Similarly, outer wing wheel actuators 80, 84 may be used to variably position the outer wing sections 32, 34 relative to the soil.

It should be appreciated that the implement 10 may also include gauge wheels 86, 88 on the outer wing sections 32, 34 to orient the fore-to-aft or pitch angle of the implement 10 relative to the soil. In such an embodiment, gauge wheel actuators 90, 92 may be provided in operative association with the gauge wheels 86, 88 to allow the pitch angle of the implement 10 to be adjusted. As shown in FIG. 1, in one embodiment, the gauge wheels 86, 88 may correspond to the forward-most ground-engaging components of the implement 10.

It should be also appreciated that, in several embodiments, the various actuators described above may correspond to hydraulically-activated actuators, such as hydraulic cylinders. In such embodiments, the flow of hydraulic fluid to the various actuators may be controlled, for example, via one or more valve assemblies 94 located on and/or within the work vehicle 14 configured to tow the implement 10. For instance, the work vehicle 14 may include a pump 96 configured to supply a flow of pressurized hydraulic fluid from a fluid supply 98 to the valve assembly (ies) 94. The valve assembly(ies) 94 may, in turn, be controlled so as to regulate the supply of hydraulic fluid to the various actuators on the implement 10. As will be described in greater detail below, the operation of the valve assembly(ies) 94 may be electronically controlled via one or more controllers of the disclosed system. An example of suitable hydraulic connections that may be made between the valve assembly(ies) 94 and the various actuators of the implement 10 are described, for example, in U.S. Pat. No. 9,609,800 (Henry), filed on Dec. 10, 2014, the disclosure of which is hereby incorporated by reference herein in its entirety for all purposes.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configurations. For example, in an alternative embodiment, the implement 10 may only include a single wing section disposed along each side of the central frame section 26 or the implement 10 may include three or more wing sections disposed along each side of the central frame section 26. Similarly, in another embodiment, any other suitable type of ground-engaging tool (or any combination of ground-engaging tools) may be coupled to or otherwise supported by the various frame sections 26, 28, 30, 32, 34 of the implement 10, including discs, shanks, tines, baskets, and/or the like.

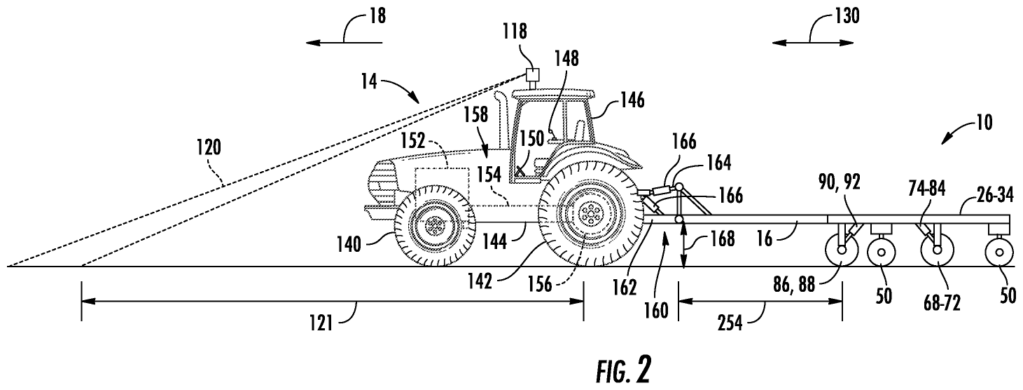

Referring now to FIG. 2, a schematic, side view of the implement 10 shown in FIG. 1 is illustrated in accordance with aspects of the present subject matter, particularly illustrating the implement 10 being towed by one embodiment of a work vehicle 14. As shown, the work vehicle 14 is configured as an agricultural tractor. However, in other embodiments, the work vehicle 14 may be configured as any other suitable work vehicle known in the art, such as any other suitable agricultural vehicle.

As shown in FIG. 2, the work vehicle 14 includes a pair of front wheels 140, a pair or rear wheels 142, and a chassis 144 coupled to and supported by the wheels 140, 142. An operator's cab 146 may be supported by a portion of the chassis 144 and may house various input devices, such as a control lever 148 and/or a foot pedal 150, for permitting an operator to control the operation of the work vehicle 14. Additionally, the work vehicle 14 may include an engine 152 and a transmission 154 mounted on the chassis 144. The transmission 154 may be operably coupled to the engine 152 and may provide variably adjusted gear ratios for transferring engine power to the wheels 142 via a drive axle assembly 156. The engine 152, transmission 154, and drive axle assembly 156 may collectively define a drive train 158 of the work vehicle 14.

Additionally, the work vehicle 14 may also include a hitch 160 for coupling the implement 10 to the vehicle 14. Specifically, in the illustrated embodiment, the pull hitch 16 of the implement 10 is coupled to the hitch 160 of the work vehicle 14 in a fully-mounted configuration. However, in other embodiments, the implement 10 may be coupled to the hitch 160 in any other suitable manner, such as in a semi-mounted configuration. As shown in the illustrated embodiment, the hitch 160 is configured as a three-point hitch and, thus, includes two lower hitch links 162 (one of which is shown) and an upper hitch link 164. However, in other embodiments, the hitch 160 may correspond to any other suitable type of hitch, such as a two-point hitch, a drawbar hitch, a scissor hitch, or any other suitable hitch type.

As shown in FIG. 2, the work vehicle 14 may also include one or more hitch actuators 166 provided in operative association with the hitch 160. In general, the hitch actuator(s) 166 may be configured to adjust the position of the hitch link(s) 160, 162 so as to vary a height 168 of the hitch 160 relative to the ground (referred to herein as the “hitch height 168”). By increasing/decreasing the hitch height 168 via adjustments made to the position of the hitch link(s) 162, 164, the inclination angle of the implement 10 may, in turn, be varied. For instance, increasing or decreasing the hitch height 168 may result in a corresponding adjustment in the fore-to-aft inclination (e.g., the pitch angle) of the implement 10 in a fore-to-aft or “pitching” direction (indicated by arrow 130) extending parallel to the travel direction 18. It should be appreciated that the hitch actuator(s) 166 may, in one embodiment, correspond to hydraulically-activated actuators, such as hydraulic cylinders. Thus, similar to the various implement-based actuators described above, the supply of hydraulic fluid to the hitch actuators 166 may be regulated via a valve assembly located onboard the work vehicle 14 (e.g., the valve assembly (ies) 94 shown in FIG. 1).

As indicated above, the implement 10 is shown in FIG. 2 as being secured to the hitch 160 in a fully mounted configuration. As such, the pull hitch 16 of the implement 10 is coupled to both the lower hitch links 162 and the upper hitch link 164. In such an embodiment, extending or contracting the hitch actuators 166 may change the position of the links 162, 164 relative to the ground, thereby adjusting the hitch height 168 and the associated inclination angle of the implement 10. However, as indicated above, in another embodiment, the implement 10 may be secured to the hitch 160 in a semi-mounted configuration in which the pull hitch 16 is only coupled to the lower hitch links 162 of the hitch 160. In such an embodiment, the position of the lower hitch links 162 may be adjusted via the corresponding hitch actuator(s) 166 to vary the hitch height 168. Of course, in embodiments in which the hitch 160 is not configured as a three-point hitch, the implement 10 may be coupled to the work vehicle 14 via any other mounting configuration suitable for use with the relevant hitch type.

It should be appreciated that, as indicated above, the inclination angle of the implement 10 may also be adjusted by varying the position of one or more of the wheels of the implement 10. For instance, the transport wheel actuators 74-84 and/or the gauge wheel actuators 90, 92 may be extended/retracted to adjust the position of the transport wheels 68-72 and/or the gauge wheels 86, 86, respectively, relative to the adjacent frame sections 26-34 of the implement 10, thereby adjusting the inclination angle of the implement 10 in one or more directions (e.g., in the pitching direction 130).

In accordance with aspects of the present subject matter, the work vehicle 14 may be provided in association with one or more field profile sensors 118 that generate or provide data indicative of the field profile associated with a forward portion of the field disposed forward of the vehicle 14 relative to the direction of travel 18. In several embodiments, the field profile sensor(s) 118 may be mounted to or supported on the work vehicle 14, with the field profile sensor(s) 118 having a field of view 120 directed towards the field. Specifically, as shown in FIG. 2, the field profile sensor(s) 118 may be supported relative to the work vehicle 14 (e.g., on top of the cab 146 of the vehicle 14) such that the field of view 120 of the sensor 118 is directed towards a forward portion of the field disposed forward of the work vehicle 14 relative to the direction of travel 18. For instance, in the illustrated embodiment, the field of view 120 of the field profile sensor(s) 118 is disposed a given look-ahead distance 121 in front of a given reference location on the vehicle 14 (e.g., the rear wheels 142 of the work vehicle 14). As such, the field profile sensor(s) 118 may be configured to generate data indicative of the surface profile or contour of the portion of the field located in front of the work vehicle. Specifically, the data generated by the field profile sensor(s) 118 may be used to detect upcoming inclined surfaces within the field that will be encountered by the work vehicle 14 and the implement 10, such as when the vehicle/implement 10 are about to encounter an upwardly sloped or downwardly sloped inclined surface within the field.

It should be appreciated that the field profile sensor(s) 118 may be configured as any suitable device that allows the sensor 118 to generate data indicative of the field profile of the portion of the field located forward of the vehicle 14. For instance, in one embodiment, the field profile sensor(s) 118 may correspond to one or more LIDAR devices configured to generate point-cloud data associated with the field profile in front of the work vehicle 14, which can be used to identify upcoming inclined surfaces within the field. In another embodiment, the field profile sensor(s) may correspond to one or more cameras (e.g., a stereo or 3-D camera(s)) configured to generate image data associated with the field profile in front of the work vehicle 14, which can similarly be used to determine upcoming inclined surfaces within the field. In other embodiments, the field profile sensor(s) 118 may correspond to any other suitable device, such as a radar sensor(s), ultrasonic sensor(s), and/or the like. It should be appreciated that, in one embodiment, different types of field profile sensors may be supported on or relative to the work vehicle 14, such as by including a combination of one or more LIDAR devices and one or more cameras.

It should also be appreciated that, while the work vehicle 14 is shown as only including or being associated with one field profile sensor(s) 118, the work vehicle 14 may include or be associated with any other suitable number of field profile sensors 118, such as two or more field profile sensors 118. Further, it should also be appreciated that the field profile sensor(s) 118 may be supported at any other suitable location on the work vehicle 14 (or the implement 10) such that the field of view 120 of the sensor 118 is directed towards the forward portion of the field in front of the vehicle 14. For instance, in another embodiment, the field profile sensor(s) 118 may be mounted or installed at the forward end of the vehicle 14.

Additionally, it should be appreciated that the configuration of the work vehicle 14 described above and shown in FIG. 2 is provided only to place the present subject matter in an exemplary field of use. Thus, it should be appreciated that the present subject matter may be readily adaptable to any manner of work vehicle configurations. For example, in an alternative embodiment, a separate frame or chassis may be provided to which the engine 152, transmission 154, and drive axle assembly 156 are coupled, a configuration common in smaller tractors. Still other configurations may use an articulated chassis to steer the work vehicle 14, or rely on tracks in lieu of the wheels 140, 142.

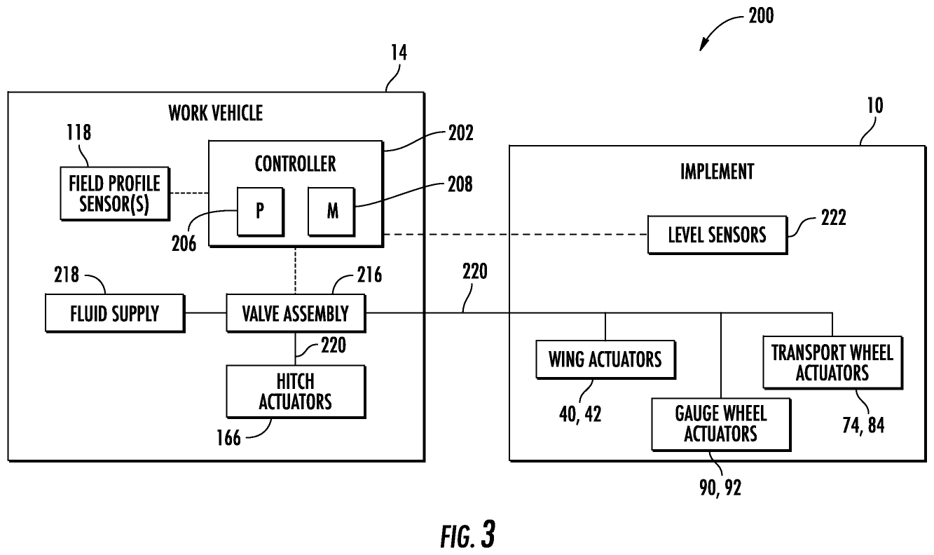

Referring now to FIG. 3, a schematic view of one embodiment of a system 200 for automatically leveling an agricultural implement being towed by a work vehicle is illustrated in accordance with aspects of the present subject matter. In general, the system 200 will be described herein with reference to the implement 10 and the work vehicle 14 described above and shown in FIGS. 1 and 2. However, it should be appreciated that the disclosed system 200 may generally be utilized with any suitable implement have any suitable implement configuration and/or with any suitable work vehicle having any suitable vehicle configuration. Additionally, it should be appreciated that hydraulic or fluid couplings of the system 200 shown in FIG. 3 are indicated by bold lines. Similarly, communicative links or electrical couplings of the system 200 shown in FIG. 3 are indicated by dashed lines.

As shown, the system 200 includes a controller 202 installed on and/or otherwise provided in operative association with the work vehicle 14. However, in other embodiments, the controller 202 may be installed on and/or otherwise provided in operative association with the implement 10. In another embodiment, the system 200 may include both a vehicle-based controller and an implement-based controller to allow for distributed computing functionality across the vehicle/implement. In such an embodiment, a communicative link or interface (e.g., a data bus) may be provided between the vehicle controller and the implement controller to allow the controllers to communicate with each other via any suitable communications protocol. Specifically, in one embodiment, an ISOBus Class 3 (ISO11783) interface may be utilized to provide a standard communications protocol between the vehicle/implement controllers.

In general, the controller 202 may correspond to any suitable processor-based device(s), such as a computing device or any combination of computing devices. Thus, in several embodiments, the controller 202 may include one or more processor(s) 206 and associated memory device(s) 208 configured to perform a variety of computer-implemented functions, such as automatically controlling the operation of one or more components of the work vehicle 14 and/or one or more components of the implement 10. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 208 of the controller 202 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 208 may generally be configured to store suitable computer-readable instructions that, when implemented by the processor(s) 206, configure the controller 202 to perform various computer-implemented functions, such as performing the various operations, control functions and/or control actions described herein and/or implementing one or more aspects of the method(s) described herein. In addition, the controller 202 may also include various other suitable components, such as a communications circuit or module, a network interface, one or more input/output channels, a data/control bus and/or the like, to allow the controller 202 to be communicatively coupled to any of the various other system components described herein.

In one embodiment, the controller 202 may be communicatively coupled to one or more valve assemblies 216 (e.g., valve assembly(ies) 94 described above with reference to FIG. 1) to regulate the supply of hydraulic fluid from a fluid tank or supply 218 (e.g., fluid supply 98 described above with reference to FIG. 1) located on the work vehicle 14. Based on control signals from the controller 202, the valve assembly (ies) 216 may regulate the supply of hydraulic fluid from the fluid supply 218 to the various actuators of the work vehicle 14 (e.g., the hitch actuators 166) as well as the various actuators of the implement 10 (e.g., the wing actuators 42, 44, the transport wheel actuators 74-84, and the gauge wheel actuators 90, 92), such as by restricting or enabling fluid flow from the fluid supply 218 into the respective actuators via one or more hydraulic lines 220, which may run throughout the vehicle 14 and across to the implement 10. As fluid is supplied into each actuator, the pressure in the associated cylinder increases, causing the actuator to extend. Correspondingly, as fluid flows out of each actuator, the pressure in the corresponding cylinder decreases, causing the actuator to retract. Thus, by controlling the operation of the valve assembly(ies) 216, the controller 202 may control the extension/retraction of the various actuators, thereby allowing the controller 202 to automatically adjust the inclination angle of the implement 10. For instance, by controlling the extension/retraction of the hitch actuator(s) 166, the hitch height 168 may be adjusted, thereby allowing for a corresponding adjustment in the inclination angle of the implement 10. Similarly, by controlling the extension/retraction of one or more of the implement-based actuators 42, 44, 74-84, 90, 92, the associated frame section(s) of the implement 10 may be raised/lowered relative to the ground, thereby allowing the inclination angle of the implement 10 to be adjusted.

Additionally, as shown in FIG. 3, the controller 202 may be communicatively coupled to one or more field profile sensors 118 configured to generate data indicative of the field profile of a forward portion of the field located forward or in front of the work vehicle 14 in the direction of travel 18. In several embodiments, the controller 202 may be configured to analyze the data received from the sensor(s) 118 to identify an upcoming inclined surface within the field (e.g., an upwardly inclined surface or a downwardly inclined surface) that will be encountered by the work vehicle along its travel path. Upon identifying the upcoming inclined surface, the controller 202 may then calculate or determine when the inclined surface will actually be encountered by the work vehicle 14. For example, based on the look-ahead distance 121 (FIG. 2) of the field profile sensor(s) 118 and the current ground speed of the work vehicle 14, the controller 202 may calculate a time delay between the instance at which the inclined surface was initially detected and the instance at which the work vehicle 14 will encounter the inclined surface (e.g., when the rear wheels 142 will encounter the inclined surface). Thereafter, based on the calculated time delay, the operation of the valve assembly(ies) 216 may be controlled so as to regulate the extension/retraction of one or more of the vehicle-based and/or implement-based actuators so as to maintain the inclination angle of the implement 10 within a desired angular inclination range(s). Specifically, in several embodiments, the extension/retraction of the hitch actuator(s) 166 may be controlled in order to adjust the hitch height 168 in a manner that maintains the inclination angle of the implement 10 within the desired angular inclination range as the work vehicle 14 travels across the inclined surface.

Additionally, upon identifying the upcoming inclined surface, the controller 202 may also calculate or determine when the inclined surface will actually be encountered by the implement 10. For example, based on the distance defined between the identified surface and the forwardmost ground-engaging component of the implement 10 (including, for example, the look-ahead distance 121 (FIG. 2) of the field profile sensor(s) 118 and a hitch distance 254 (FIG. 2) defined between the hitch 160 and the forwardmost ground-engaging component) and the current ground speed of the work vehicle 14, the controller 202 may calculate a time delay between the instance at which the inclined surface was initially detected and the instance at which the implement 10 will encounter the inclined surface (e.g., when the forwardmost ground-engaging component of the implement 10 will encounter the inclined surface). Thereafter, based on the calculated time delay, the operation of the valve assembly(ies) 216 may be controlled so as to regulate the extension/retraction of one or more of the vehicle-based and/or implement-based actuators so as to maintain the inclination angle of the implement 10 within a desired angular inclination range. Specifically, in several embodiments, the extension/retraction of the hitch actuator(s) 166 may be controlled in order to adjust the hitch height 168 while simultaneously controlling the extension/retraction of the gauge wheel actuators 90, 92 in a manner that maintains the inclination angle of the implement 10 within the desired angular inclination range as the implement 10 travels across the inclined surface.

As an alternative to calculating the time delay for determining when the implement 10 will encounter an inclined surface, the controller 202 may, instead, be configured to actively monitor the inclination angle of the implement 10 via one or more implement-based level sensors 222 supported on the implement 10. In such an embodiment, based on the data received from the level sensor(s) 222, the controller 202 may determine when the implement 10 begins to encounter an inclined surface and subsequently initiate suitable control actions for maintaining the inclination angle of the implement 10 within the desired angular inclination range. Additionally, as will be described below, the implement-based level sensor(s) 222 may also be used for closed-loop control when adjusting the inclination angle of the implement 10.

It should be appreciated that, in several embodiments, the implement-based level sensor 222 may correspond to an inclinometer, such as a single axis inclinometer, a two-axis inclinometer, or a three-axis inclinometer. For instance, in one embodiment, the level sensor(s) 222 may be configured to measure the fore-to-aft inclination (e.g., the pitch angle) of the implement 10 in the fore-to-aft or “pitching” direction 130 (FIG. 2) and/or the side-to-side inclination (e.g., the roll angle) of the implement 10 in a side-to-side or “rolling” direction extending perpendicular to the travel direction 18. In other embodiments, the level sensor(s) 222 may correspond to any other suitable sensor(s) or sensing device(s) that may provide an indication of the angle of inclination of the implement 10, such as gyroscopes, accelerometers, height sensors (e.g., radar or sonar sensors), and/or the like.

As indicated above, by identifying inclined surfaces out in front of the work vehicle 14, the controller 202 may proactively determine the appropriate control action(s) for maintaining the implement 10 at a level orientation as the work vehicle 14 travels across the inclined surface and as the implement 10 subsequently begins to travel across the inclined surface. As a result, the system responsiveness for maintaining the implement 10 at a level orientation may be increased significantly. In several embodiments, the control action(s) selected by the controller 202 may be based on a determination of whether the vehicle/implement will be traveling up or down the inclined surface. In addition, the control action(s) may be selected based on a determination of whether the vehicle/implement will be traveling up/down the inclined surface at an angle (e.g., due to the inclined surface having a roll angle associated therewith).

In one embodiment, the controller 202 may be configured to initially adjust the position of the hitch 160 in one direction as the work vehicle 14 begins to travel across an inclined surface (but prior to the implement traveling across such inclined surface) to vary the hitch height 168 in a manner that maintains the inclination angle of the implement 10 within the desired angular inclination range. However, as the ground-engaging components of the trailing implement 10 subsequently begin to traverse across the inclined surface, the position of the hitch 160 may be adjusted in the opposite direction to ensure that the inclination angle of the implement 10 is maintained within the desired inclination range. As will be described below, the positions of one or more of the wheels supported on the implement 10 (e.g., the gauge wheels 90, 92) may also be adjusted in combination with the hitch position control in order to maintain the inclination angle of the implement 10 within the desired angular inclination range, such as during the time across which the ground-engaging components of the implement 10 begin to contact and travel up/down the inclined surface.

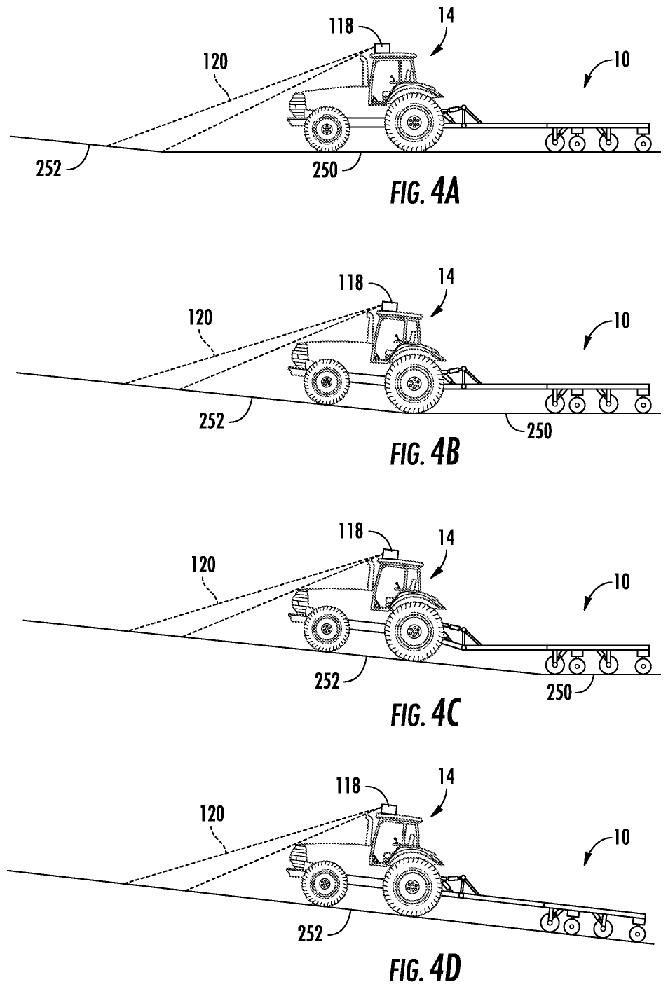

For example, FIGS. 4A-4D illustrate a series of views in which a work vehicle 14 and an implement 10 transition from a level surface 250 to an upwardly inclined surface 252 as the implement 10 is being towed by the work vehicle 14. Specifically, FIG. 4A illustrates a side view of the vehicle/implement 14, 10 as the work vehicle 14 begins to approach the inclined surface 252. FIG. 4B illustrates a subsequent side view of the vehicle/implement 14, 10 as the work vehicle 14 initially begins to travel up the inclined surface 252 (e.g., when both the front and rear wheels 140, 142 are traveling up the inclined surface 252) while the implement 10 is still traveling along the level surface 250. FIG. 4C illustrates a subsequent side view of the vehicle/implement 14, 10 after the work vehicle 14 has moved further up the inclined surface 252 and just as the forwardmost ground-engaging components of the implement 10 (e.g., the gauge wheels 86, 88) begin to contact the inclined surface 252. Additionally, FIG. 4D illustrates a side view of the vehicle/implement 14, 10 with both the work vehicle 14 and the implement 10 fully positioned on and traversing the inclined surface 252.

Referring initially to FIG. 4A, as indicated above, the field profile sensor(s) 118 may be used to look-out in front of the work vehicle 14 to identify upcoming inclined surfaces, such as the inclined surface 252 shown in the illustrated embodiment. As such, based on the look-ahead distance 121 (FIG. 2) of the sensor(s) 118 and the ground-speed of the work vehicle 14, the controller 202 may be configured to determine a time delay associated with when the work vehicle will encounter and begin to travel across the detected surface 252. Suitable control actions may then be determined by the controller 202 for maintaining the desired orientation of the implement 10 as the work vehicle 14 (and, subsequently, the implement 10) transition onto the inclined surface 252.

As shown in FIG. 4B, as the work vehicle 14 begins to travel up the inclined surface 252, the controller 202 may be configured to execute one or more initial control actions. For instance, in several embodiments, the controller 202 may be configured to control the operation of the hitch actuator(s) 166 based on the calculated time delay such that the hitch 160 is moved downwardly in the direction of the inclined surface 252 as the work vehicle 14 begins to travel up the inclined surface 252, thereby reducing the hitch height 168. As a result, the implement 10 may be maintained level as the vehicle 14 travels up the inclined surface.

It should be appreciated that the actuation of the hitch 160 can be controlled in any suitable manner, including closed-loop control and/or open-loop control. For instance, in one embodiment, the controller 202 may be configured to execute a closed-loop control algorithm in which the hitch position is adjusted based on feedback received from the implement-based level sensor(s) 222. In such an embodiment, the hitch position may be adjusted downwardly based on the monitored inclination angle of the implement 10 as the work vehicle 14 begins to travel up the inclined surface 252. Alternatively, the controller 202 may be configured to implement an open-loop control algorithm in which the hitch position is adjusted based on the current ground speed of the work vehicle 14 and the hitch distance 254 (FIG. 2) defined between the hitch 160 and the forward-most ground-engaging component of the implement 10. In such an embodiment, the hitch position may be adjusted downwardly at a given rate determined as a function of the ground speed and the hitch distance 254.

Additionally, as shown in FIG. 4C, the controller 202 may be configured to execute one or more control actions for maintaining the implement 10 within a desired angular inclination range as the forwardmost ground-engaging components of the implement 10 (e.g., the gauge wheels 86, 88) contact and begin to travel up the inclined surface 252. For instance, in one embodiment, the controller 202 may be configured to simultaneously control the operation of both the hitch actuator(s) 166 and the gauge wheel actuators 90, 92 to maintain the implement within the desired angular inclination range as the ground-engaging components begin to travel up the inclined surface 252. Specifically, the operation of the hitch actuator(s) 166 may be controlled such that the hitch 160 is moved upwardly in the direction away from the inclined surface 252, thereby increasing the hitch height 168. For instance, the position of the hitch 160 may be moved back towards the original position at which it was located prior to the work vehicle 14 beginning to travel up the inclined surface 252. Additionally, simultaneous with executing the hitch position control, the operation of the gauge wheel actuators 90, 92 may be controlled so as to raise the gauge wheels 86, 88 relative to their adjacent frame sections, thereby lowering the front ends of the frame sections to maintain the implement 10 within the desired angular inclination range as the ground-engaging components being to travel up the inclined surface 252.

As indicated above, it should be appreciated that, by knowing the look-ahead distance 121 of the field profile sensor(s) 118 and the hitch distance 254 (as well as the current ground speed of the implement 10), the controller 202 may be configured to determine exactly when the forwardmost ground-engaging components will encounter the inclined surface 252 (e.g., based on the calculated time delay). Alternatively, in instances in which the implement 10 is equipped with one or more implement-based level sensor 222, the controller 202 may determine that the forwardmost ground-engaging components have encountered the inclined surface based on the data received from the level sensor(s) 222.

It should also be appreciated that the actuation of the gauge wheels 86, 88 can be controlled in any suitable manner, including closed-loop control and/or open-loop control. For instance, in one embodiment, the controller 202 may be configured to implement a closed-loop control algorithm in which the gauge wheel position is adjusted based on feedback received from the implement-based level sensor(s) 222. Thus, as the ground-engaging components of the implement 10 contact and begin to travel up the inclined surface 252, the gauge wheel position may be actively adjusted based on the sensor feedback to maintain the inclination angle(s) of the implement 10 within the desired angular inclination range(s).

Moreover, as shown in FIG. 4D, by the time that the work vehicle 14 and the implement 10 have fully transitioned to the inclined surface 252, the hitch 160 and gauge wheels 86, 88 may have been returned back to the original positions at which they were located prior to the vehicle 14 beginning to traverse the inclined surface 252. For instance, as indicated above, when the forward-most ground-engaging component initially contacts the inclined surface 252, the hitch position may begin to be adjusted back up towards its original position. Similarly, as the implement 10 begins to transition onto the inclined surface 252, the gauge wheel position may be initially raised to maintain the implement level and may then be subsequently lowered back to its original position as the implement 10 fully transitions to the inclined surface 252.

It should be appreciated that the above-described sequence of operations simply provides one example of suitable control actions that may be performed when a work vehicle 14 and implement 10 are transitioning onto an inclined surface. However, the sequence of operations and/or the specific control actions taken may vary in other scenarios, such as when the inclined surface differs from that shown in FIGS. 4A-4D. For instance, when the work vehicle 14 and implement 10 are transitioning to a downwardly inclined surface, the control actions may differ, at the very least, in the direction of the hitch/wheel position control. Specifically, as the work vehicle 14 initially begins to travel down the inclined surface, the hitch 160 may be raised relative to the surface to maintain the implement 10 within a desired angular inclination range. Thereafter, as the gauge wheels 86, 88 begin to travel down the inclined surface, the hitch 160 may be lowered back towards its initial position while the gauge wheels 86, 88 are simultaneously being extended to raise the front ends of the frame sections. In such an embodiment, by the time the implement 10 has fully transitioned to the downwardly inclined surface, both the hitch 160 and the gauge wheels 86, 88 may be returned back to their original positions.

It should also be appreciated that the specific sequence of operations and/or control actions taken may vary depending on whether the vehicle/implement 14, 10 are traveling straight up/down the inclined surface as opposed to traveling across the inclined surface at an angle. For instance, if the vehicle/implement 14, 10 are traveling straight up/down the inclined surface, the control actions taken by the controller 202 may be focused on maintaining the pitch angle(s) of the implement 10 within the corresponding desired pitch angle range(s), such as by adjusting the position of the hitch 160 and/or the gauge wheels 86, 88. However, if the vehicle/implement 14, 10 are traveling up/down the inclined surface at an angle such that the roll angle of the implement 10 will vary as the implement 10 transitions to the inclined surface, the controller 202 may be configured to execute control actions that take into account the potential for variations in both the pitch angle and the roll angle of the implement 10. For instance, in addition to simply adjusting the position of the hitch 160 and/or the gauge wheels 86, 88 to prevent undesirable changes in the pitch angle of the implement 10, the controller 202 may also be configured to vary the wheel position control across the differing wing sections. Specifically, as an example, if the vehicle/implement 14, 10 are traveling relative to the inclined surface such that the right-side wing sections 28, 32 will contact the inclined surface prior to the left-side wing sections 30, 34, the controller 202 may be configured to adjust the position of one or more of the wheels supported on the right-side wing sections 28, 32 in a manner different than the wheels supported on the left-side wing sections 30, 34, such as by actuating one or more wheels supported on the right-side wing sections 28, 32 prior to the wheels supported on the left-side wing sections 30, 34 or by actuating one or more of the wheels supported on the right-side wing sections 28, 32 in a different direction than the wheels supported on the left-side wing sections 30, 34.

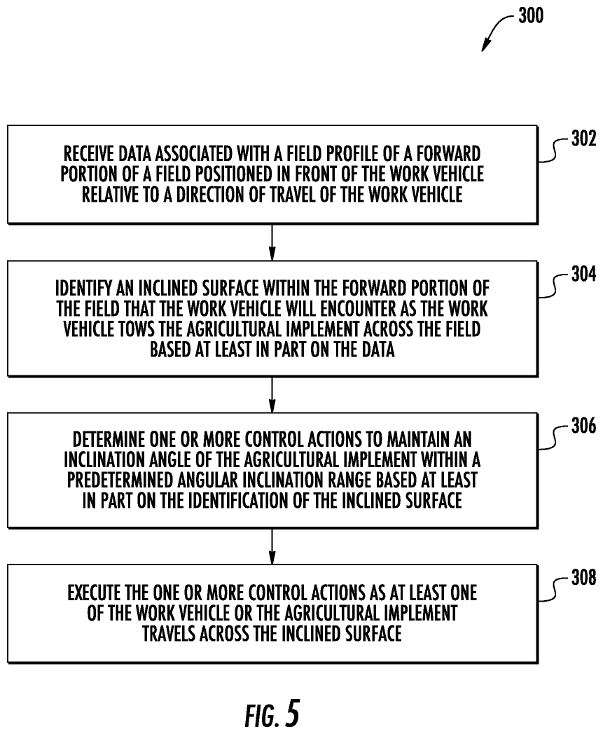

Referring now to FIG. 5, a flow diagram of one embodiment of a method 300 for automatically leveling an agricultural implement being towed by a work vehicle is illustrated in accordance with aspects of the present subject matter. In general, the method 300 will be described herein with reference to the implement 10 and the work vehicle 14 shown in FIGS. 1 and 2 as well as the system 200 shown in FIG. 3. However, it should be appreciated that the disclosed method 300 may be executed with implements and/or work vehicles having any other suitable configurations and/or with systems having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 may include receiving data associated with a field profile of a forward portion of a field positioned in front of the work vehicle relative to a direction of travel of the work vehicle. Specifically, as indicated above, the controller 202 may be configured to receive data associated with a forward portion of the field located out in front of the work vehicle 14 from one or more field profile sensors 118 supported relative to the vehicle 14.

Additionally, at (304), the method 300 may include identifying an inclined surface within the forward portion of the field that the work vehicle will encounter as the work vehicle tows the agricultural implement across the field based at least in part on the data. For example, as indicated above, the controller 202 may be configured to analyze the data received from the field profile sensor(s) 118 to identify an inclined surface (e.g., an upwardly sloped surface or a downwardly sloped surface) out in front of the work vehicle 14.

Moreover, at (306), the method 300 may include determining one or more control actions to maintain an inclination angle of the agricultural implement within a predetermined angular inclination range based at least in part on the identification of the inclined surface. As indicated above, the controller 202 may be configured to select one or more control actions for execution based on, for example, whether the vehicle/implement will be traveling upward or downward along the inclined surface and/or whether the inclined surface exhibits a roll angle. Suitable control actions may include, but are not limited to, controlling the operation of the hitch actuator(s) 166 of the work vehicle 14 and/or any of the various implement-based actuators of the implement 10.

Referring still to FIG. 5, at (308), the method 300 may include executing the one or more control actions as at least one of the work vehicle or the agricultural implement travels across the inclined surface. For instance, as indicated above, the controller 202 may, in one embodiment, be configured to execute one or more initial control actions as the work vehicle 14 transitions onto the inclined surface (but before the implement 10 transitions onto such surface) and then execute one or more subsequent control actions as the implement 10 subsequently transitions on the inclined surface.

It is to be understood that the steps of the method 300 may be performed by the controller 202 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 202 described herein, such as the method 300, may be implemented in software code or instructions which are tangibly stored on a tangible computer readable medium. The controller 202 loads the software code or instructions via a direct interface with the computer readable medium or via a wired and/or wireless network. Upon loading and executing such software code or instructions by the controller 202, the controller 202 may perform any of the functionality of the controller 202 described herein, including any steps of the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for automatically leveling an agricultural implement being towed by a work vehicle, the method comprising:
receiving, with a computing device, data associated with a field profile of a forward portion of a field positioned in front of the work vehicle relative to a direction of travel of the work vehicle;
identifying, with the computing device, an inclined surface within the forward portion of the field that the work vehicle will encounter as the work vehicle tows the agricultural implement across the field based at least in part on the data;
determining, with the computing device, one or more control actions to maintain an inclination angle of the agricultural implement within a predetermined angular inclination range based at least in part on the identification of the inclined surface; and
executing, with the computing device, the one or more control actions as at least one of the work vehicle or the agricultural implement travels across the inclined surface.

2. The method of claim 1, wherein receiving the data comprises receiving the data from a field profile sensor supported relative to the work vehicle.

3. The method of claim 2, wherein the field profile sensor comprises at least one of a LIDAR device, a camera, a radar sensor, or an ultrasound sensor.

4. The method of claim 2, further comprising determining a time delay for executing at least one control action of the one or more control actions based at least in part on a look-ahead distance of the field profile sensor.

5. The method of claim 4, wherein determining the time delay comprises determining the time delay based at least in part on the look-ahead distance of the field profile sensor and a hitch distance associated with the agricultural implement.

6. The method of claim 1, wherein executing the one or more control actions comprises adjusting a position of a hitch of the work vehicle to maintain the inclination angle within the predetermined angular inclination range as the at least one of the work vehicle or the agricultural implement travels across the inclined surface.

7. The method of claim 6, wherein adjusting the position of the hitch comprises:
initially adjusting the position of the hitch in a first direction to maintain the inclination angle within the predetermined angular inclination range as the work vehicle travels across the inclined surface; and
adjusting the position of the hitch in a second direction opposite the first direction to maintain the implement inclination angle within the predetermined angular inclination range as at least one ground-engaging component of the implement travels across the inclined surface.

8. The method of claim 7, wherein executing the one or more control actions further comprises adjusting a position of the at least one ground-engaging component relative to at least one frame section of the implement in combination with adjusting the hitch height in the second direction to maintain the implement inclination angle within the predetermined angular inclination range as the at least one ground-engaging component travels across the inclined surface.

9. The method of claim 6, wherein, when the inclined surface corresponds to an upwardly inclined surface, the first direction corresponds to a downward direction towards the inclined surface and the second direction corresponds to an upward direction away from the inclined surface.

10. The method of claim 6, wherein, when the inclined surface corresponds to a downwardly inclined surface, the first direction corresponds to an upward direction away from the inclined surface and the second direction corresponds to a downward direction towards away the inclined surface.

11. A system for automatically leveling an agricultural implement being towed by a work vehicle, the system comprising:
a field profile sensor supported relative to the work vehicle and being configured to generate data associated with a field profile of a forward portion of a field positioned in front of the work vehicle relative to a direction of travel of the work vehicle;
a controller communicatively coupled to the field profile sensor, the controller being configured to:
identify an inclined surface within the forward portion of the field that the work vehicle will encounter as the work vehicle tows the agricultural implement across the field based at least in part on the data received from the field profile sensor;
determine one or more control actions to maintain an inclination angle of the agricultural implement within a predetermined angular inclination range based at least in part on the identification of the inclined surface; and
execute the one or more control actions as at least one of the work vehicle or the agricultural implement travels across the inclined surface.

12. The system of claim 11, wherein the field profile sensor comprises at least one of a LIDAR device, a camera, a radar sensor, or an ultrasound sensor.

13. The system of claim 11, wherein the controller is further configured to determine a time delay for executing at least one control action of the one or more control actions based at least in part on a look-ahead distance of the field profile sensor in front of the work vehicle.

14. The system of claim 13, wherein the controller is configured to determine the delay time based at least in part on the look-ahead distance of the field profile sensor and a hitch distance associated with the agricultural implement.

15. The system of claim 11, wherein the one or more control actions comprises adjusting a position of a hitch of the work vehicle to maintain the inclination angle within the predetermined angular inclination range as the at least one of the work vehicle or the agricultural implement travels across the inclined surface.

16. The system of claim 15, wherein adjusting the position of the hitch comprises:
initially adjusting the position of the hitch in a first direction to maintain the inclination angle within the predetermined angular inclination range as the work vehicle travels across the inclined surface; and
adjusting the position of the hitch in a second direction opposite the first direction to maintain the implement inclination angle within the predetermined angular inclination range as at least one ground-engaging component of the implement travels across the inclined surface.

17. The system of claim 16, wherein the one or more control actions further comprise adjusting a position of the at least one ground-engaging component relative to at least one frame section of the implement in combination with adjusting the hitch height in the second direction to maintain the implement inclination angle within the predetermined angular inclination range as the at least one ground-engaging component travels across the inclined surface.

18. The system of claim 17, wherein the at least one ground-engaging component comprises a wheel of the agricultural implement.

19. The system of claim 16, wherein, when the inclined surface corresponds to an upwardly inclined surface, the first direction corresponds to a downward direction towards the inclined surface and the second direction corresponds to an upward direction away from the inclined surface.

20. The system of claim 16, wherein, when the inclined surface corresponds to a downwardly inclined surface, the first direction corresponds to an upward direction away from the inclined surface and the second direction corresponds to a downward direction towards away the inclined surface.
